(19) United States
(12) Patent Application Publication
(10) Pub. No.: US 2005/0166434 A1
(43) Pub. Date: Aug. 4, 2005

(54) Inflatable display apparatus

(76) Inventor: William Richard Barlow, Malibu, CA (US)

Correspondence Address: BACON & THOMAS, PLLC, 625 SLATERS LANE, FOURTH FLOOR, ALEXANDRIA, VA, 22314, US

(21) Appl. No.: 10/768,072

(22) Filed: Feb. 2, 2004

(51) Int. Cl. G09F 15/00

(52) U.S. Cl. 40/610; 40/624

(57) ABSTRACT

An inflatable display apparatus including at least one inflatable platform having a plurality of walls surrounding a base portion, and at least one inflatable display attached to the platform. The inflatable display is configured to extend from the platform when inflated and be generally contained within the walls of the platform when deflated. A method is included comprising providing inflatable display apparatus, inflating an inflatable display on the basis of a preselected criteria, and deflating the inflatable display after inflating the inflatable display such that the inflatable display is generally contained within the walls of the platform when deflated.

This application claims the benefit of U.S. Provisional Applications ______ filed concurrently on Nov. 19, 2003 that provide the basis of the following disclosure.

### BACKGROUND OF THE INVENTION

1. Field of the Invention

The invention relates to an inflatable display apparatus. When used in a marine environment, the display apparatus comprises a ballast system including at least one elongate ballast mounted to a bottom surface thereof to provide stability and guidance while floating on a water surface.

2. Discussion of Related Art

Outdoor billboard and advertising installations are well known. For many years, billboards have been installed along the nation's highways and have served as useful tool for reaching driving audiences. Advertising installations such as electric signs are commonly used by vendors to attract customers and provide notice of events. Billboards and advertising installations are also frequently used at local events and attractions such as fairs, festivals, retail establishments and sporting events.

Another type of outdoor advertising is the use of portable billboards or banners carried by planes, automobiles and blimps. For example, it is well known to fly airplanes or blimps carrying banners or graphic presentations that promote local events, services or products above crowds gathered at sporting events, parks and city streets. Moreover, it is also common to employ a truck or van to transport a billboard display in crowded cities and towns advertising a new product, event or service.

Heretofore, there has been no successful portable outdoor advertising scheme employed for a marine environment such as those directed to crowds along waterfronts or coastlines. It is thus highly desirable to provide a display apparatus capable of providing an advertising scheme capable of reaching crowded beaches or parks located along a waterfront or coastline.

An increasing problem is being encountered pertaining to laws and local ordinances prohibiting, limiting or requiring licensing of billboards and other forms of outdoor advertising. Often these regulations relate to the degree of permanency of advertising matter, being more stringent the more permanent the advertising installation becomes. Regulations vary from outright bans on billboards along interstate highways, waterfronts, and coastlines to restrictions on sign styles and size above a business establishment.

Advertisement of alcohol and tobacco products is severely limited through radio and television, and modes of outdoor advertising of the types discussed above are frequently used instead. Nonetheless, many localities place restrictions or even outright bans on advertising of alcohol and tobacco on beaches, and accordingly, it is difficult to reach crowds of beachgoers with alcohol and tobacco advertising. Moreover, advertisers in general have very few outlets to reach beach crowds and are typically limited to trash can ads, bus benches, parking lot fliers or airplanes. It will be noted, however, that offshore areas a certain distance from the shore are often exempt from local ordinances since such waters are outside the jurisdiction of these localities. Accordingly, crowds of beachgoers can be reached with advertising if such advertising is located a distance from shore.

To overcome many of the impediments of known modes of advertising, it has been proposed to provide an advertising display apparatus that can reach crowds along a waterfront or coastline while complying with local ordinances or capable of displaying advertisements a distance from a waterfront or coastline outside of such local jurisdictions. Moreover, it is desirable to provide a display apparatus of simple construction that is versatile in that it may be used in both marine environments and on dry ground, and further may be easily adaptable to include different advertising displays.

### SUMMARY OF THE INVENTION

In accordance with the invention, different embodiments of display apparatuses having numerous variations are provided which satisfy existing needs for a display apparatus that can carry an advertising display, and is useable in both a marine environment and on dry ground.

The present invention provides an inflatable display apparatus including at least one inflatable platform having a plurality of walls surrounding a base portion, and at least one inflatable display attached to the platform. The inflatable display is configured to extend from the platform when inflated and be generally contained within the walls of the platform when deflated. The present invention also provides a method including steps of providing an inflatable display apparatus, inflating an inflatable display based on a preselected criteria, and deflating the inflatable display after inflating the inflatable display such that the inflatable display is generally contained within the walls of the platform when deflated.

In accordance with an embodiment of the invention, a display apparatus comprises an inflatable platform having a plurality of walls surrounding a base portion, and an inflatable display mounted along the first surface of the platform and configured to extend from a first side of the platform when inflated. The display apparatus of this embodiment may comprise a ballast system and such ballast system includes a plurality of elongate ballasts extending along the longitudinal length of a second side of the base portion of the platform assembly. Numerous interactive features may be provided for this embodiment such as lighting, sound, moveable parts, sensor configurations and any other feature deemed suitable for attracting and communicating with people.

Conventional display apparatuses are typically dull, expensive, and restricted in a particular application or environment. Moreover, such display apparatuses are mainly one-dimensional and limited in size. The embodiments of the display apparatus of this invention can be located in a variety of locations, and are particularly adapted for a marine environment for reaching a viewing audience along a waterfront or coastline. When in a marine environment, the display apparatus may be adapted to be towed by a watercraft in reversible directions and further, multiple display apparatuses may be connected to one another in a train formation and towed simultaneously by such watercraft. Furthermore, the display apparatus may include self-propulsion and navigational devices controlled by radio or wirelessly which permit the display apparatuses to be transported without a watercraft.

The display apparatus may carry a variety of advertising displays, and further be adapted to carry public service announcements. Whether it is a display panel or an inflatable display, the display apparatus can accommodate message areas that can be personalized or tailored to meet any viewing audience. In addition, the display apparatus can be scaled to meet any appropriate application, and may include interactive features for attracting and communicating with people.

The new and novel embodiments of the display apparatus are versatile in that they may be used on both dry ground and marine environments. Operation of the display apparatus is generally uncomplicated, safe and does not pose a public nuisance. Moreover, due to its inflatable nature, the display apparatus is simple in construction, relatively inexpensive to manufacture, and can be stored with ease in minimal spaces.

### BRIEF DESCRIPTION OF THE DRAWINGS

Objects and many attendant advantages of the present invention will be readily appreciated as the same becomes better understood by reference to the following detailed description when considered in connection with the accompanying drawings in which like reference numerals designate like parts throughout the figures thereof and wherein:

FIG. 1 is a schematic perspective view of a display apparatus being towed by a watercraft;

FIG. 2 is an elevational side view of a display apparatus according to a first embodiment of the invention;

FIG. 3 is top plan view of the display apparatus of FIG. 2;

FIG. 4 is a front elevational view of the display apparatus of FIG. 2;

FIG. 5 is perspective sectional view of a ballast in FIG. 2;

FIG. 6 is a perspective view of a tow device in FIG. 2;

FIG. 7 is a perspective view of a lighting configuration of FIG. 2;

FIG. 8 is an elevational sectional view of another embodiment of the display apparatus of the invention;

FIG. 9 is an elevational side view of the display apparatus exemplified in FIG. 8;

FIG. 10 is an elevational front view of the display apparatus exemplified in FIG. 8; and

FIG. 11 is a top plan view of the display apparatus exemplified in FIG. 8.

### DETAILED DESCRIPTION OF THE PREFERRED EMBODIMENTS

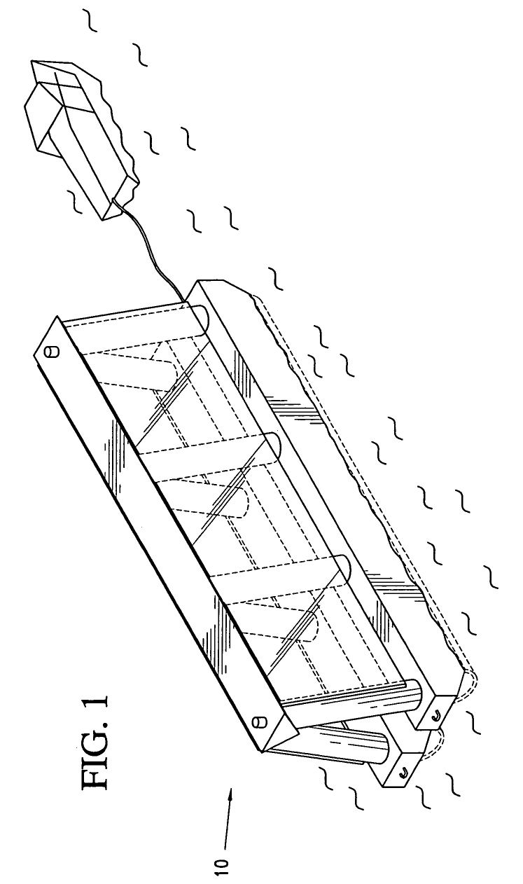

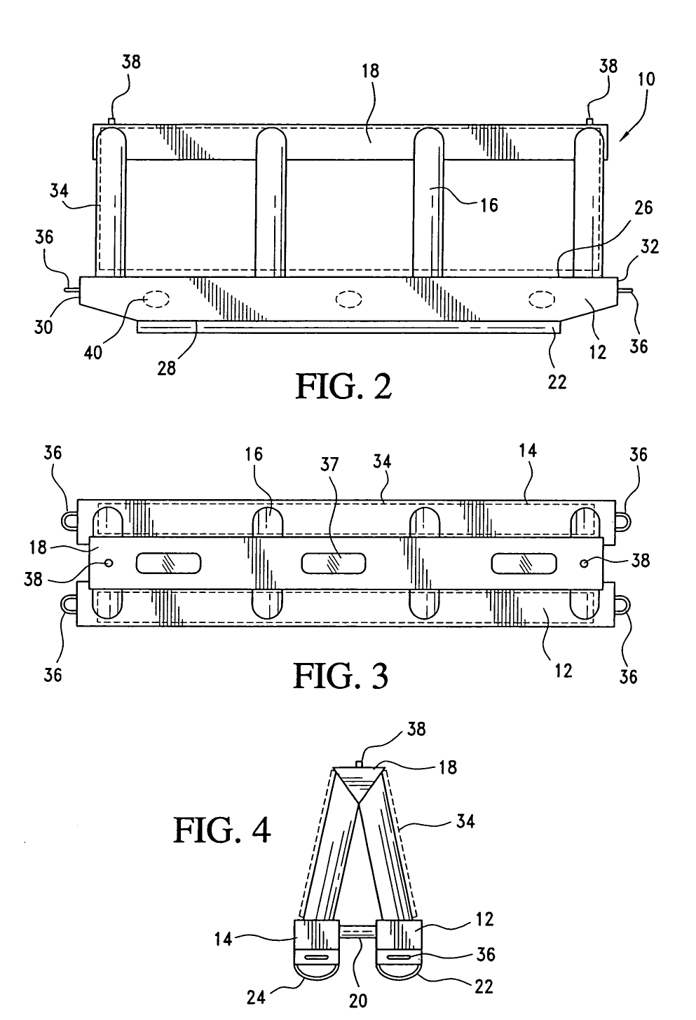

Turning to FIG. 1, an embodiment of the display apparatus 10 is depicted as being towed by a watercraft. This embodiment is depicted in greater detail in FIGS. 2-4, wherein the display apparatus 10 comprises two elongate pontoons 12, 14 provided in parallel arrangement. Each pontoon 12, 14 is defined as having opposed first and second ends 30, 32, and first and second sides 26, 28. The display apparatus 10 further comprises a plurality of column members 16 that extend from the first side 26 of each of the pontoons 12, 14 and are preferably arranged in uniformly spaced rows. Each of the column members 16 connects to an elongate transverse member 18 spaced above and provided in parallel arrangement to the pontoons 12, 14. Moreover, the display apparatus 10 further comprises at least one cross-tube 20 that connects to and extends laterally between the pontoons 12, 14.

As shown in FIG. 4, the display apparatus 10 is generally trapezoidal in lateral cross-section such that the transverse member 18 generally defines a narrow top portion and the column members 16 extend therefrom at an acute angle, preferably in the range of 10 to 20° to the pontoons 12, 14. The pontoons 12, 14 define a wider bottom portion with the at least one cross-tube 20 extending between the pontoons 12, 14. This trapezoidal shape improves the stability of the display apparatus in the event of wind and inclement conditions and further provides a structure that enables clear visibility of a display panel attached to each row of column members.

Preferably, in this embodiment the pontoons, the column members, the transverse member and the cross-tubes each comprise at least one inflatable compartment. Each compartment is provided with a valve, such as a two-way Boston valve, and is separately inflatable. Moreover, it is preferred that the pontoons, column members, the transverse member, and the cross-tubes are constructed from water impermeable and an air-tight material, such as Tarpaulin or PVC coated vinyl, and include seams that are sewn, bonded, or both sewn and bonded together such as by radio frequency (RF) welding. Each of the members of the display apparatus may be constructed so as to have an internal bladder constructed of PVC and an external shell constructed of Tarpaulin.

The display apparatus 10 of this embodiment is arranged to support at least one display panel 34 that is removably affixed to at least one row of the column members 16 and generally extends between the transverse member 18 and one of the pontoons 12, 14. The display panel 34 may be a banner, placard, billboard or the like which is generally planar and has a leading edge, a trailing edge and two longitudinal edges. The leading and trailing edges of the display panel 34 can be connected to column members 16 corresponding to the first and second ends 30, 32 of the pontoons 12, 14. The display panel may be configured to extend along one of the rows of column members, or be configured to individually extend along both rows of the column members and over the transverse member. Moreover, the display panel 34 may comprise three-dimensional items such as inflatable objects and may include lighting elements disposed thereon.

The display panel 34 can be connected along its leading and trailing edges to corresponding column members and a corresponding longitudinal edge may be connected to the transverse member. Preferably, in one embodiment, the display panel, the transverse member and the column members include a plurality of matching fastener elements, such as stainless steel grommets, hook and loop fasteners, snap elements and the like, that are mounted, such as by being RF welded, to the aforesaid components of the display apparatus. The column members and transverse member in this embodiment include flaps that are attached thereto and which include a plurality of the fastener elements.

In one embodiment, the fastener elements are stainless steel grommets which are mounted on the flaps and the display panel. A nylon rope can be used to maintain the display panel sufficiently in place to the members of the display apparatus thereby permitting easy mounting and dismounting of the display panel.

Other configurations of the display panel and members of the display apparatus are intended to be within the scope of the instant application which may be used to connect the display panel to the display apparatus to maintain the display panel with the display apparatus in light to moderate winds, and inclement weather conditions, withstand towing by a watercraft, or be maintained in a stationary fashion.

Preferably, the display panel 34 comprises a billboard made of pliable and permeable material bearing graphic presentations including symbols, indicia, images and the like. The display panel may be constructed from any suitable material, such as nylon-poly mesh, that will permit the flow of air therethrough and the display of such display panel in light to moderate wind and inclement weather conditions.

Alternatively, the display panel may comprise a string of lights or an electronic sign instead of the aforementioned billboard-like display panel. Moreover, the display panel may include LCD and/or LED elements mounted thereon providing illumination or a visual display screen with moving images.

As shown in FIGS. 2-4, the display apparatus includes a ballast system 22, 24 mounted along the second side 28 of each of the pontoons 12, 14. In a preferred embodiment, the ballast system comprises elongate ballasts 22, 24 that define a conduit for the flow of fluid therethrough. Each pontoon 12, 14 is provided with an elongate ballast 22, 24 that extends generally along the second surface 28 thereof.

The ballasts 22, 24 may extend along the entire second surface 28 of the pontoons 12, 14, or may extend only along a selected portion thereof. The ballast system may comprise a plurality of ballast segments mounted in a parallel or staggered configuration along the second surface of the pontoons, and further, the ballast segments may be mounted along side portions of the pontoons that are in contact with water.

Preferably, the ballasts are constructed of a material suitable for use in watercraft, such as Tarpaulin. While in the preferred embodiment the cross-sectional shape of the ballasts is shown to be semi-circular, the ballasts may define a plurality of shapes, such as circular, triangular, square and a variety of other suitable geometrical configurations.

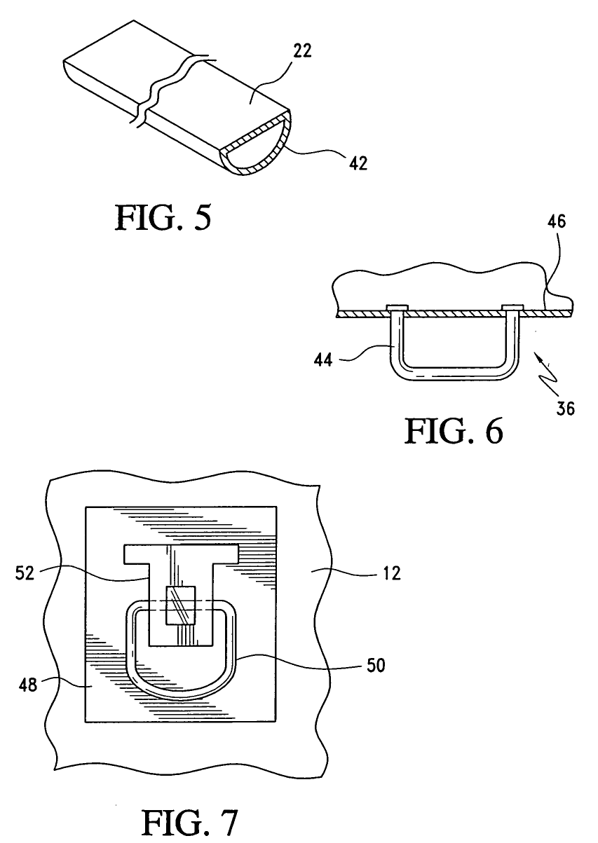

As illustrated in FIG. 5, each ballast 22 preferably includes opposed end portions having sections reinforced with a structural material 42, such as PVC, or having an inflated configuration whereby the end portions have gas chambers that maintain the ballast as an open conduit. The end portions may be sealed such that the fluid contained by the ballasts is trapped therein. Maintenance of the ballasts as an open conduit is desirable so at to prevent collapse of the ballasts and provide ample fluid transport therethrough.

The ballast system is provided as a means to maintain the display apparatus in upright position so as to prevent the display apparatus from tipping or flipping in inclement weather conditions. Moreover, the ballast system provides the display apparatus with directional guidance when it is floating on a body of water. It will be noted, however, that the ballast system may be removed from the display apparatus in the event the display apparatus is positioned on dry around.

When on dry ground, the display apparatus may be provided with removable axles carrying wheels that can be mounted, for example, on the second surface of the pontoons to facilitate the transport of the display apparatus on dry ground or along marine launching ramps. Furthermore, if the display apparatus is to be exhibited on dry ground, the ballasts may be filled with weight, such as water or sand. For example, bags or tubes filled of sand or water may be inserted into the interior area of the ballasts and the ballasts may be sealed at each end portion thereof to contain the weight therein.

As shown in FIGS. 2-4, the display apparatus 10 may include at least two tow devices 36 provided at the first and second ends 30, 32 of the pontoons 12, 14. In FIG. 6, a tow device 36 is depicted and includes an attachment element 44 mounted to a segment 46 of waterproof material, such as Tarpaulin. The segment of material 46 is subsequently mounted to an end of the pontoons as shown in FIGS. 2-4. Each tow device 36 may be mounted to the pontoons in any suitable manner, such by being sewn, bonded, or sewn and bonded by RF welding. The tow devices enable the display assembly to be towed generally in a straight line and provide stability and control when maneuvered.

A rope, cable or other suitable line element may be tied at one end to the preferred tow device and tied at another end to a watercraft towing the display apparatus. Multiple display apparatuses may be linked to one another by suitable line elements provided between the tow devices, whereby a train of at least two display apparatuses may be towed simultaneously by a watercraft.

The tow device of the invention is not limited to the aforementioned tow device, and any tow device may be employed which permits the display apparatus to be connected to a watercraft and subsequently towed thereby without separation of the display apparatus from the watercraft.

High wind tracking of the display apparatus may be provided to improve the navigation of the display apparatus by including a drag chute funnel or any other suitable drag control devices or arrangement. For example, the drag chute funnel may be connected at a trailing end of the display apparatus whereby the diameter of the funnel is adjustable in size to regulate the flow of water therein and therefore the drag of the display apparatus.

The display apparatus may include with an on-board propulsion arrangement such as a gas or electric motor. Moreover, the display apparatus may include a navigational arrangement, such as a mountable rudder, a keel, or other suitable marine navigational components known to those skilled in the art, as a substitute for or in combination with the ballast system. Such on-board propulsion and navigational arrangements may be provided with radio or wireless control features so as to render a towing watercraft unnecessary and permit someone along shore to direct the floating display apparatus.

The display apparatus may include a plurality of different lighting configurations having decorative and functional features. More specifically, in a preferred embodiment, the display apparatus includes a plurality of pockets positioned on the top of each of the columns wherein battery operated navigation lights 38 are provided. Spotlights or lamps 40 may be provided alongside the pontoons, and LCD/LEDs may be appropriately positioned on the display apparatus and panel as deemed necessary for a desired viewing display. Any of the lighting configurations can be provided with receivers that are arranged to receive radio or wireless control signals for operation thereof.

In a preferred embodiment shown in FIG. 7, a segment 48 of heat resistant material, such as that constructed of asbestos, may be mounted on the pontoons 12, 14. The heat resistant segment 48 is provided with a ring 50 which is sewn, bonded or welded thereon. An airtight, waterproof halogen light fixture 52 or similar light fixture may be strapped onto such heat resistant segment 48 with the fixture of a glass lens of the halogen light fixture 52 generally directed toward a display panel supported by the display apparatus. The halogen light fixture 52 may be connected to a power source carried by the display apparatus or on board a watercraft towing the display apparatus.

The display apparatus is not limited to the aforementioned lighting fixtures, and may include a variety of lighting configurations that may illuminate portions of the display panel, provide navigational means for the display apparatus, form portions of the display panel such as lighting elements, illuminate structural members of the display apparatus, and other lighting configurations rendered necessary or elected to be included on a display apparatus supporting display panels. Underwater lights may also be provided which cause the periphery of the display apparatus to glow in water.

The lighting configurations may be battery operated, or connected to a power source carried by the display apparatus, a watercraft, or a land based source. In the embodiment shown in FIG. 3, the power source comprises a plurality of solar panels 37 connected to an appropriate energy storage device. The solar panels may be placed any suitable location to receive solar radiation.

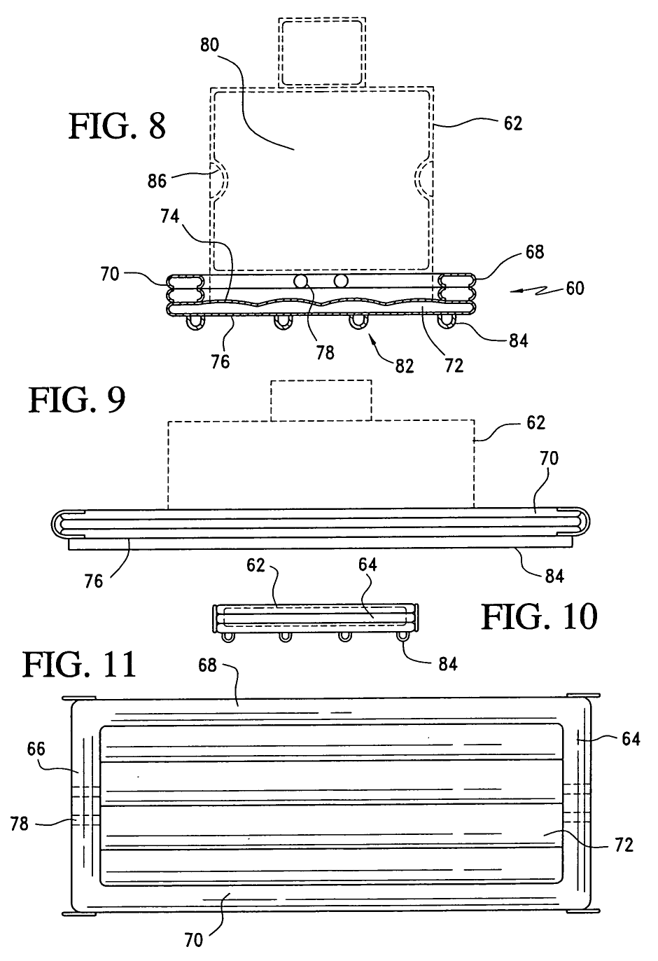

In another embodiment of the invention exemplified in FIGS. 8-11, the display apparatus 60 comprises a platform assembly 60 configured with an inflatable display 62. In this embodiment, the platform assembly 60 comprises a plurality of wall members 64, 66, 68, 70 surrounding a first surface 74 of a base member 72. The walls are divided into opposed first and second end walls 64, 66 and opposed first and second side walls 68, 70. The base member 72 comprises the first surface 74 and a second surface 76 opposed to the first surface 74.

In the preferred embodiment, the walls 64, 66, 68, 70 of the platform assembly 60 are mounted to the first surface of the platform. The walls are defined by a plurality of circuitous, separately inflatable members that may be connected to one another in a vertically arranged formation. In alternate embodiments, each wall may be defined as a separately inflatable member, or comprise of a plurality of inflatable members that may be vertically or horizontally arranged. Moreover, the walls may be comprised of a single inflatable member having different compartments or chambers which are separately inflatable.

The base portion 72 of the platform assembly 60 preferably comprises a plurality of separately inflatable members. The inflatable members of the base portion 72 may comprise a plurality of horizontally arranged longitudinally extending members generally parallel with the side walls 68, 70, a plurality of laterally extending members generally parallel with the end walls 64, 66 any combination of longitudinally and laterally horizontally extending members, or any deviation thereof. Moreover, the base portion 72 may comprise a plurality of members horizontally arranged, as described above, or vertically arranged.

The platform assembly 60 may also comprise a ballast assembly 82, as described above in connection with display apparatus 10. The ballast assembly 82 includes at least one elongate ballast 84 mounted on the second surface 76 of the base portion 72. As with the ballast assembly described above, the at least one elongate ballast 84 is particularly defined for providing a conduit of fluid to pass therethrough when the platform assembly is floating on a water surface. Moreover, as with the display apparatus 10 the at least one ballast may be filled with a weight, such as sand or water, and sealed at the end portions thereof in the event the platform assembly is on dry ground so as to maintain the platform assembly in a stable position.

In accordance with this embodiment, the platform assembly may be constructed of a water impermeable material, such as PVC coated vinyl. Preferably, the seams of the members comprising the platform assembly are sewn, bonded, or sewn and bonded with water impermeable threads and RF welded to provide air and water tight seals.

The inflatable display 62 is preferably made of a substantially flexible sheet material such as a polymer material, or any other material commonly used for making inflatable toys or rafts. Further, the material should be capable of being heat sealed. Preferably, the inflatable display is a three-dimensional form and may include a message area. Moreover, the inflatable display may comprise at least one individually inflatable compartment.

The inflatable display can be sewn to the first surface 74 of the base portion 72 of the platform assembly and then RF welded thereto, connected to the base portion 72 via fastener elements such as hook and loop or snap fasteners, lashed to the platform assembly in a manner similar to the mounting fastener and flap arrangement discussed above in relation to display apparatus 10, or connected to the platform assembly in any other known manner.

At least one blower duct 78 providing a conduit of pressurized gas, such as air, is preferably defined through one of the walls portions 64, 66, 68, 70 and is in communication with at least one interior volume 80 of the inflatable display 62 and a gas pressurizing source. Multiple blower ducts may be provided which either connect to respective interior volumes of the inflatable display, or connect to a single interior volume of the inflatable display. The inflatable display is provided with suitable valves which permit the expulsion of pressurized gas so the inflatable display may be deflated. The gas pressurizing source may be provided external to the platform assembly, or a gas pressurizing source may be provided on the platform assembly itself.

The inflatable display 62 preferably includes at least one pocket 86 containing a weight to maintain the display 62 in a desired shape upon inflation and deflation thereof. The pocket 86 may be defined as an underside of an inner or outer layer of the material used to construct the inflatable display. The weight can be any object or composition thereof, such as sand, which substantially maintains the display in a desired position or controls movement upon deflation thereof.

To inflate the inflatable display 62, a gas such as air is forced through the blower ducts to pressurize the interior volume. As the inflatable display inflates, the inflatable display rises from the base portion 72 of the platform assembly to increase in size. Once inflation is complete, the inflatable display 62 remains stationary and is supported by the platform assembly.

As shown in FIG. 10, when deflated the inflatable display 62 is contained within the walls 64 of the platform assembly 60. The inflatable display 62 is made to be self-supporting on the platform assembly 60, whether the platform assembly is located on dry ground or on a water surface and the inflatable display is able to stand erect and balanced by means of the platform assembly. Moreover, stability of the platform assembly and thus the inflatable display is enhanced by the ballast system 82, as discussed above in connection with display apparatus 10.

It will be understood that the inflatable display may include a variety of lighting, sound, motion sensors and interactive features such as smoke effects or water spraying capabilities. For example, the inflatable display may comprise the shape of a shark head having a mouth which includes lighting focused on the shark head and sound effects of a splash as the shark head projects water from its mouth. The shark head is configured to rise and fall, inflate and deflate according to motion sensors which detect the presence of individuals. These interactive features may be powered by a power source such a battery, solar panels connected to a battery, electric generator or power outlet connected to the platform assembly. Moreover, the interactive features of the display device may be programmed in a desired fashion such as in a time cycle or acting upon the detection of at least one individual by motion sensors.

The inflatable display may be inflated or deflated based on a preselected criteria. For example, the inflatable display may inflate and deflate based on a predetermined time cycle such as inflating every 10 minutes and remaining inflated for five minutes. On the other hand, the display apparatus may be provided with motion sensors which detect at least one individual within a predefined area and inflate upon detection of such at least one individual. Deflation, in turn, may be caused by the departure of the at least one individual from the predefined area.

The platform assembly may additionally comprise tow devices and lighting configurations such as those described above in reference to display apparatus 10. Moreover, the platform assembly 62 may similarly be towed by a watercraft as the display apparatus 10 was shown in FIG. 1.

In all of the embodiments of the invention, it will be understood that structural members of the display apparatus may comprise singular or multiple inflatable members that may be separately inflatable. According to the invention, the structural members are preferably separately inflatable so as to minimize any leaks and reduce collapse of the display apparatus in the event any of the inflatable structural members rupture. Moreover, the structural members are provided with suitable valves that permit the selective entrance and expulsion of gas, such as air, therethrough.

The display apparatus of the invention may be scaled to any appropriate size, and be configured for either outdoor or indoor use. Moreover, the display apparatus is not limited to including the ballast system described herein, by may be modified to include any appropriate base deemed suitable for the particular application of the display apparatus.

Inflation of the members of the display apparatus may be accomplished either by permanent inflation, that is single inflation which lasts until the device is collapsed, or, and preferably, on-site blowers used to continuously force air within the interior of the inflatable members to maintain a desirable air pressure therein.

It will be understood that the above described embodiments of the invention may assume a variety of different shapes, sizes and configurations without departing from the scope of the present invention.

It will be understood that the above described embodiments of the invention are illustrative in nature, and that modifications thereof may occur to those skilled in the art. Accordingly, this invention is not to be regarded as limited to the embodiments disclosed herein, but is to be limited only as defined in the appended claims.

1. A display apparatus, comprising:
at least one inflatable platform assembly including a plurality of walls surrounding a base portion, the plurality of walls defining first and second side walls and first and second end walls, and the base portion defining first and second surfaces; and
at least one inflatable display attached to the platform assembly, said inflatable display configured to extend from the first side of the platform assembly when inflated.

2. The display apparatus according to claim 1, further comprising a plurality of elongate ballasts mounted to the second side of the platform assembly.

3. The display apparatus according to claim 1, wherein the inflatable display is in communication with a continuously operable blower device.

4. The display apparatus according to claim 3, wherein the platform assembly defines at least one blower duct defined along a first side thereof for communication with a blower device to inflate at least one interior compartment of the inflatable display.

5. The display apparatus according to claim 1, wherein the inflatable display includes a plurality of pockets configured to contain at least one weight, said pockets arranged so as to provide control of the shape of the media element upon deflation thereof.

6. The display apparatus according to claim 1, wherein the inflatable display has at least one inflatable interior compartment.

7. The display apparatus according to claim 1, wherein the platform assembly includes a plurality of individually inflatable compartments.

8. The display apparatus according to claim 1, wherein the inflatable display is configured so as to be contained within the walls of the platform assembly when deflated.

9. An inflatable display apparatus, comprising:
an inflatable platform including a plurality of walls surrounding a base portion; and
at least one inflatable display attached to the platform, said inflatable display configured to extend from the platform when inflated and be generally contained within the walls of the platform when deflated.

10. The display apparatus according to claim 9, wherein the inflatable display includes a plurality of pockets configured to contain at least one weight, said pockets arranged so as to provide control of the shape of the media element upon deflation thereof.

11. The display apparatus according to claim 9, wherein the inflatable display has at least one inflatable interior compartment.

12. The display apparatus according to claim 9, wherein the platform includes a plurality of individually inflatable compartments.

13. The display apparatus according to claim 9, further comprising a plurality of elongate ballasts mounted to the platform.

14. The display apparatus according to claim 9, wherein the platform is provided with at least one pocket configured to contain at least one weight.

15. A method of advertising, the method comprising the steps of:
providing a display apparatus having a platform including a plurality of walls surrounding a base portion, and at least one deflated inflatable display attached to the platform;
inflating the at least one inflatable display on the basis of a preselected criteria; and
deflating the inflatable display after inflating the inflatable display wherein said at least one inflatable display is generally contained within the walls of the platform when deflated.

16. The method according to claim 15, further comprising the step of floating the platform upon a surface of water.

17. The method according to claim 15, wherein the preselected criteria is a cycle based on time intervals of inflation and deflation of the inflatable display.

18. The method according to claim 15, wherein the preselected criteria is based on detection of at least one individual person.

19. The method according to claim 15, further comprising the step of illuminating the at least one inflatable display upon inflation of the at least one inflatable display.

20. The method according to claim 15, further comprising the step of providing sound effects upon inflation of the at least one inflatable display.
